(19) United States
(12) Patent Application Publication
(10) Pub. No.: US 2007/0256098 A1
(43) Pub. Date: Nov. 1, 2007

(54) Digital television receiver and method for processing a digital television signal

(76) Inventor: Hyung Sun Yum, Incheon (KR)

Correspondence Address: Song K. Jung;MCKENNA LONG & ALDRIDGE LLP, 1900 K Street, N.W., Washington, DC, 20006, US

(21) Appl. No.: 11/790,776

(22) Filed: Apr. 27, 2007

(30) Foreign Application Priority Data
Apr. 28, 2006 (KR) 10-2006-0039049

(51) Int. Cl. H04N 5/445

(52) U.S. Cl. 725/38

(57) ABSTRACT

A digital television (DTV) receiver receives and processes a program specific information/program and system information protocol (PSI/PSIP) including a virtual channel table (VCT). At this time, the VCT comprises a traffic descriptor including traffic information.

Accordingly, the DTV receiver processes the traffic information and displays the traffic information.

This application claims the benefit of Korean Patent Application No. 10-2006-0039049, filed on Apr. 28, 2006, which is hereby incorporated by reference as if fully set forth herein.

### BACKGROUND

1. Field of the Disclosure

The present disclosure relates to a digital television (DTV) receiver and a method for processing the (DTV) signal.

2. Background

As digital television (DTV) technologies are developed, users have experienced high technologies such as high-definition (HD) moving pictures and Dolby digital audio. As compression algorithms and high-performance hardware are continuously developed, users will experience better environment.

A DTV receiver can provide an audio and video (A/V) service. The DTV receiver can provide additional services such as an A/V service using a program specific information/program and system information protocol (PSI/PSIP) table. The PSI/PSIP table includes, for example, a virtual channel table (VCT) containing a list of attributes of the virtual channels contained in transport streams. In the PSI/PSIP, each table contains one or more descriptors for providing additional information.

The DTV receiver can provide data broadcast, the users can be provided additional services, for example, news, weather, traffic, stocks service and etc.

### SUMMARY

Accordingly, the present disclosure is directed to a digital television (DTV) receiver and a method for processing a DTV signal that substantially obviate one or more problems described above.

For example, the disclosure may disclose a DTV receiver and a method for processing a DTV signal, by which traffic information may be displayed a user.

Advantages, objects, and features of the invention in part may become apparent in the description which follows and in part may become apparent to those having ordinary skill in the art upon examination of the following or may be learned from practice of the invention. The objectives and other advantages of the various embodiments of the invention may be realized and attained by the structures and processes described in the written description, in the claims, and in the appended drawings.

To achieve these objects and other advantages and in accordance with the purpose of the invention, as embodied and broadly described herein, a method includes receiving a digital television signal including a virtual channel table carrying a list of attributes for virtual channels carried in transport streams included in the digital television signal; parsing the virtual channel table, the parsed virtual channel table comprising traffic information defining traffic status associated with one or more roads; and displaying the parsed traffic information.

In another aspect, a digital television receiver includes a tuner arranged to receive a digital television signal; a demodulator arranged to demodulate the digital television signal; a demultiplexer arranged to demultiplex a virtual channel table from the demodulated digital television signal; a decoder arranged to parse the virtual channel table, the parsed virtual channel table comprising a traffic information; a display unit arranged to display the parsed traffic information; and a controller arranged to control operation of the decoder and the display unit.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIG. 1 is an exemplary diagram of bit stream syntax for TVCT;

FIG. 2 is an exemplary diagram of a traffic descriptor;

FIG. 3 is a block diagram of an exemplary digital television receiver; and

FIG. 4 is an exemplary flowchart of a method for processing a digital television signal including traffic information.

### DETAILED DESCRIPTION

Reference will now be made in detail to a digital television (DTV) receiver and a method for processing the DTV signal according to the various embodiments, examples of which are illustrated in the accompanying drawings. Wherever possible, the same reference numbers will be used throughout the drawings to refer to the same or like parts for simplicity. In addition, although the terms used in the present invention are selected from generally known and used terms, some of the terms mentioned in the description of the present disclosure have been selected by the applicant at his or her discretion, the detailed meanings of which are described in relevant parts of the description herein. Furthermore, it is required that the present disclosure is understood, not simply by the actual terms used but by the meanings of each term lying within.

The DTV receiver can provide users with a variety of additional services such as news, weather, traffic, and securities information using a program specific information/program and system information protocol (PSI/PSIP) established in advanced television system committee (ATSC).

Hereinafter, in association with, for example, the traffic information in the variety of additional services provided by the DTV receiver, a method for processing traffic information included in a DTV signal will be described. The DTV signal may comprise traffic information in any one of the tables of the PSI/PSIP which is the standard for carrying broadcast information of a system. It is assumed that the traffic information is included in a virtual channel table (VCT) and is defined in the form of a descriptor of the VCT. For example, the descriptor is called a traffic descriptor.

The traffic information may be most useful to users. As the mobile broadcasting era such as digital multimedia broadcasting is regularized, the utility of the traffic information will increase.

Hereinafter, the present disclosure will be described in order of (1) a DTV signal including traffic information, (2) a DTV receiver, and (3) a method for processing the DTV signal.

(1) A Digital Television Signal Including Traffic Information

In the DTV signal including the traffic information, the VCT comprising the traffic information will be first described.

In general, the PSIP including the VCT is used for terrestrial and cable digital broadcasting. A transmitter can encode a program in a moving picture experts group-2 (MPEG-2) format and transmit the encoded program and a receiver can receive and parse the encoded program to provide a variety of information on a program. The receiver may be, for example, the DTV receiver.

Accordingly, the PSIP has a structure similar to that of program specific information (PSI) and includes a set of tables having the same purpose. The tables may be divided into a plurality of sections, which are then transmitted. In the structure of the sections obtained by combining data structures, each of all the sections begins at a “table_id” field and finishes at a “CRC_{—}32” field. At this time, each section is divided into a header comprising a common form, a message body comprising actual data recorded according to a purpose, and a trailer for error checking and correction. In the VCT section, the header comprises a “table_id” field to a “protocol_version” field, the message body comprises a “num-channels_in_section” field to an “additional_descriptors_length” field, and the trailer comprises a “CRC_{—}32” field. For convenience of description, name of fields constructing the syntaxes are marked by double quotation marks.

Generally, a virtual channel table (VCT) includes a list of attributes for virtual channels carried in the Transport Stream (TS). The basic information comprised in the VCT message body includes TSID, channel number (major and minor), short channel name, program number, access controlled flag, location field for extended text messages, and service type. Additional information may be carried by descriptors which may be placed in the descriptor loop after the basic information.

The VCT may be segmented into as many as 256 sections. One section may contain information for several virtual channels, but the information for one virtual channel should not be segmented and put into two or more sections. Thus for each section, the first field after protocol_version should be num_channels_in section. Each virtual channel is associated with a program_number. Every program element associated with that program_number should be considered to be a part of that virtual channel.

The VCT includes a terrestrial virtual channel table (TVCT) for terrestrial broadcasting and a cable virtual channel table (CVCT) for cable broadcasting. Hereinafter, for convenience of description, it is assumed that the traffic descriptor is included in the terrestrial virtual channel table (TVCT).

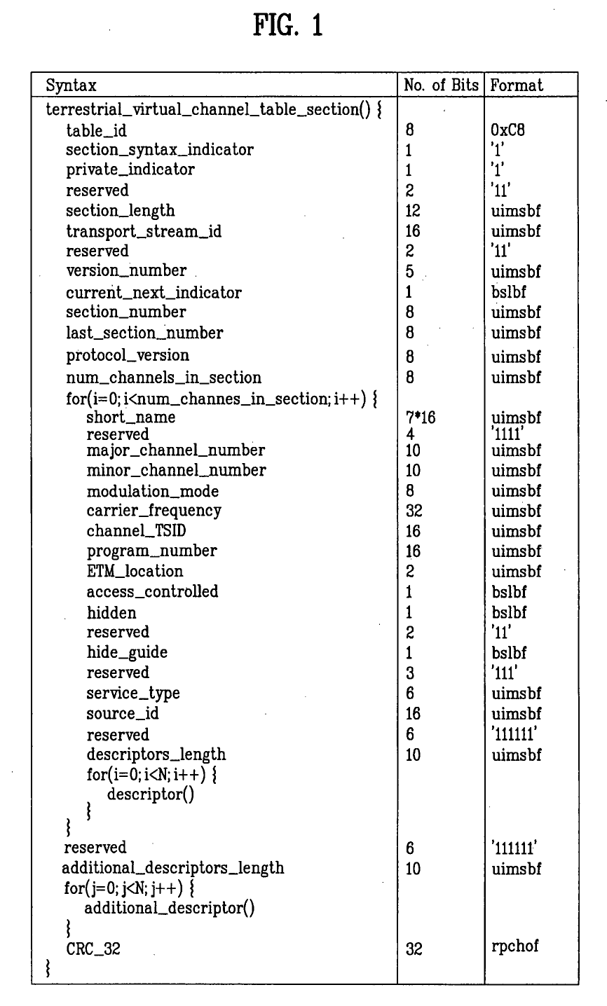

FIG. 1 is an exemplary diagram of bit stream syntax for the TVCT.

First, the header will be described. A “table_id” is an 8-bit field, which should be set to ‘0xC8’, identifying this table as the TVCT. A “section_syntax_indicator” is a 1-bit field, which should be set to ‘1’, for the terrestrial_virtual_channel_table_section( ).

A “private_indicator” is a 1-bit field that should be set to ‘1’. A “section_length” is a 12-bit field, the first two bits of which should be ‘00’. It specifies the number of bytes of the section, starting immediately following the section_length field, and including the cyclic redundancy check (CRC). The value in this field should not exceed 1021. A “transport_stream_id” is a 16-bit MPEG-2 TSID, as it appears in the program association table (PAT) identified by a packet identifier (PID) value of zero for this multiplex. The transport_stream_id distinguishes this TVCT from others that may be broadcast in different PTCs.

A “version_number” is a 5-bit field that is the version number of the VCT. For the current VCT (current_next_indicator=‘1’), the version number should be incremented by 1 whenever the definition of the current VCT changes. Upon reaching the value 31, it wraps around to 0. For the next VCT (current_next_indicator=‘0’), the version number should be one unit more than that of the current VCT (also in modulo 32 arithmetic). In any case, the value of the version_number should be identical to that of the corresponding entries in the MGT. A “current_next_indicator” is a 1-bit indicator, which when set to ‘1’ indicates that the VCT sent is currently applicable. When the bit is set to ‘0’, it indicates that the table sent is not yet applicable and should be the next table to become valid.

A “section_number” is an 8-bit field that gives the number of this section. The section_number of the first section in the TVCT should be ‘0x00’. It should be incremented by one with each additional section in the TVCT. A “last_section_number” is an 8-bit field that specifies the number of the last section (that is, the section with the highest section_number) of the complete TVCT. A “protocol_version” is an 8-bit unsigned integer field whose function is to allow, in the future, this table type to carry parameters that may be structured differently than those defined in the current protocol.

Next, the message body will be described. A “num_channels_in_section” is an 8-bit field that specifies the number of virtual channels in this VCT section. A “short_name” is the name of the virtual channel, represented as a sequence of one to seven 16-bit code values interpreted in accordance with the UTF-16 representation of Unicode character data.

A “major_channel_number” is a 10-bit number that represents the major channel number associated with the virtual channel being defined in this iteration of the ‘for’ loop. Each virtual channel should be associated with a major and a minor channel number. The major channel number, along with the minor channel number, act as the user's reference number for the virtual channel. The major_channel_number should be between 1 and 99. The value of major_channel_number should be set such that in no case is a major_channel_number/minor_channel_number pair duplicated within the TVCT. A “minor_channel_number” is a 10-bit number in the range 0 to 999 that represents the ‘minor’ or ‘sub’ channel number. This field, together with major_channel_number, performs as a two-part channel number, where minor_channel_number represents the second or right-hand part of the number. When the service_type is analog television, the minor_channel_number should be set to 0. Services whose service_type is either ATSC digital_television or ATSC_audio_only should use minor numbers between 1 and 99. The value of minor_channel_number should be set such that in no case is a major_channel_number/minor_channel_number pair duplicated within the TVCT. For other types of services, such as data broadcasting, valid minor virtual channel numbers are between 1 and 999.

A “modulation_mode” field is an 8-bit unsigned integer number that indicates the modulation mode for the transmitted carrier associated with this virtual channel. For digital signals, the standard values for modulation mode (values below 0x80) indicate transport framing structure, channel coding, interleaving, channel modulation, forward error correction, symbol rate, and other transmission-related parameters, by means of a reference to an appropriate standard. The modulation_mode field should be disregarded for inactive channels. A “carrier_frequency” is the recommended value for these 32 bits is zero. Use of this field to identify carrier frequency is allowed, but is deprecated. A “channel_TSID” is a 16-bit unsigned integer field in the range 0x0000 to 0xFFFF that represents the MPEG-2 TSID associated with the TS carrying the MPEG-2 program referenced by the virtual channel. For inactive channels, channel_TSID should represent the ID of the TS that will carry the service when it becomes active. The receiver is expected to use the channel_TSID to verify that any received TS is actually the desired multiplex. For analog channels (service_type 0x01), channel_TSID should indicate the value of the analog TSID included in the vertical blanking interval (VBI) of the national television system committee (NTSC) signal.

A “program_number” is a 16-bit unsigned integer number that associates the virtual channel being defined here with the MPEG-2 Program Association and TS Program Map tables. For virtual channels representing analog services, a value of 0xFFFF should be specified for program_number. For inactive channels (those not currently present in the TS), program_number should be set to zero. This number should not be interpreted as pointing to a program map table (PMT) entry.

An “ETM_location” is a 2-bit field that specifies the existence and the location of an extended text message (ETM). An “access_controlled” is a 1-bit Boolean flag that indicates, when set, that the events associated with this virtual channel may be access controlled. When the flag is set to ‘0’, event access is not restricted.

A “hidden” is a 1-bit Boolean flag that indicates, when set, that the virtual channel is not accessed by the user by direct entry of the virtual channel number. Hidden virtual channels are skipped when the user is channel surfing, and appear as if undefined, if accessed by direct channel entry. Typical applications for hidden channels are test signals and NVOD services. Whether a hidden channel and its events may appear in EPG displays depends on the state of the hide_guide bit. A “hide_guide” is a Boolean flag that indicates, when set to ‘0’ for a hidden channel, that the virtual channel and its events may appear in electronic program guide (EPG) displays. This bit should be ignored for channels which do not have the hidden bit set, so that non-hidden channels and their events may always be included in EPG displays regardless of the state of the hide_guide bit. Typical applications for hidden channels with the hide_guide bit set to ‘1’ are test signals and services accessible through application-level pointers.

A “service type” is a 6-bit enumerated type field that should identify the type of service carried in this virtual channel. A “source_id” is a 16-bit unsigned integer number that identifies the programming source associated with the virtual channel. In this context, a source is one specific source of video, text, data, or audio programming. Source ID value zero is reserved. Source ID values in the range 0x0001 to 0x0FFF should be unique within the TS that carries the VCT, while values 0x1000 to 0xFFFF should be unique at the regional level. Values for source_IDs 0x1000 and above should be issued and administered by a Registration Authority designated by the ATSC.

A “descriptors_length” is the total length (in bytes) of the descriptors for this virtual channel that follows. A descriptor may include one or more descriptors, as appropriate. At this time, the descriptor includes a traffic descriptor. The detailed description of the traffic descriptor will be made later. An “additional_descriptors_length” is the total length (in bytes) of the VCT descriptor list that follows.

Finally, the trailer will be described. A “CRC_{—}32” is a 32-bit field that comprises the CRC value that ensures a zero output from the registers in the decoder after processing the entire TVCT section.

Up to now, the syntax for TVCT according to the present disclosure was described. As described above, in the present disclosure, the traffic information is defined in the descriptor of the TVCT in the tables of the PSIP. Next, a descriptor for traffic information of the TVCT will be described.

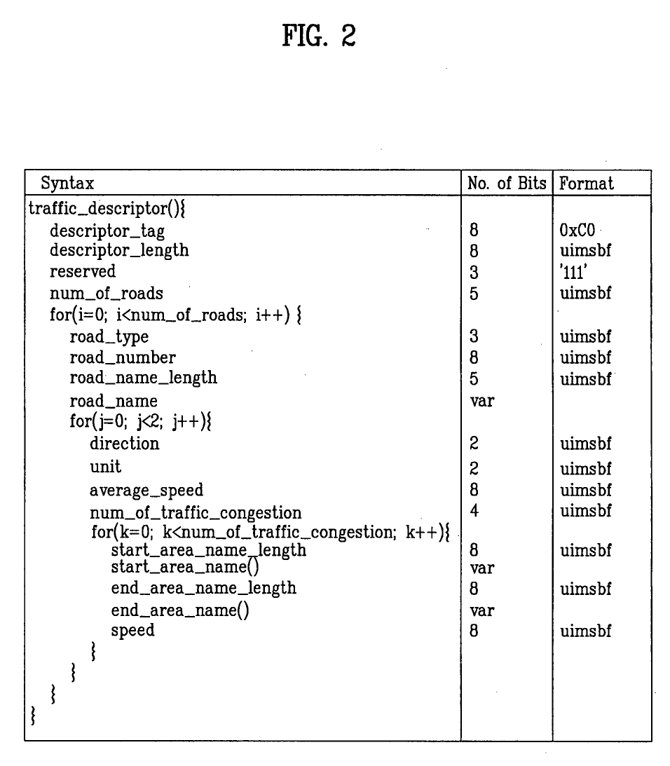

FIG. 2 is an exemplary diagram of a traffic descriptor. Next, the fields of the traffic descriptor will be described.

A “descriptor_tag” identifies the descriptor and may have a value of ‘0xC0’. A “descriptor_length” may indicate the total length (in bytes) of a field that follows.

A “num_of_roads” is a 5-bit field that indicates the number of roads. More detailed information of the roads defined in the “num_of_roads” field is contained in a loop structure.

Hereinafter, the loop structure of the roads defined in the “num_of_roads” field will be described. A “road_type” is a 3-bit field that indicates the type of the road. The type may include, for example, any one of a freeway, state highway, avenue, street, boulevard, and drive. That is, the type of the road is the freeway when the value of the “road_type” field is, for example, ‘000’, is the state highway when the value of the “road_type” field is, for example, ‘001’, is the avenue when the value of the “road_type” field is, for example, ‘010’, is the street when the value of the “road_type” field is, for example, ‘011’, is the boulevard when the value of the “road_type” field is, for example, ‘100’, and is the drive when the value of the “road_type” field is, for example, ‘101’. The remaining field values ‘110’ to ‘111’ are reserved for the future use.

A “road_number” is an 8-bit unique identification (ID) number of each road. A “road_name” is a variable-bit field indicates the name of the road, and the length of the name is indicated in a “road_name_length” field. At this time, both the “road_number” and “road_name” fields may be included as unique information about the road. Alternatively, one of the fields may be included if the road can be identified by only at least one of the “road_number” and “road_name” fields.

A user can know to which road the traffic information transmitted through the traffic descriptor corresponds, using the information in the loop structure. Next, the traffic state of the road may be defined in a loop structure. In FIG. 2, the loop structure of the “road_name” field is exemplarily illustrated.

Hereinafter, the loop structure of the “road_name” field will be described. This is information for providing convenience to the user who uses the traffic information.

A “direction” is a 2-bit field that indicates a reference direction of the traffic information provided to the identified road. For example, the direction is a direction from north to south when the value of the “direction” field is ‘00’, is a direction from south to north when the value of the “direction” field is ‘01’, is a direction from west to east when the value of the “direction” field is ‘10’, and the direction is a direction from east to west when the value of the “direction” field is ‘11’. Accordingly, the user can know the reference direction of the provided traffic information and accurately use the information.

A “unit” is a 2-bit field that indicates the reference speed unit of the traffic information provided with respect to the identified road. The speed unit includes, for example, ‘km/h’ or ‘miles/h’. That is, the reference speed unit of the provided traffic information is ‘km/h’ when the value of the “unit” field is ‘00’ and is ‘miles/h’ when the value of the “unit field is ‘01’. Other reference speed units may use values ‘10’ to ‘11’.

An “average_speed” is an 8-bit field that indicates the average speed of vehicles on the identified road. At this time, the average speed is provided in the reference speed unit indicated in the “unit” field. Accordingly, the user can know the average speed of the vehicles on the road and infer whether the corresponding road is in a congestion state.

A “num_of_traffic congestion” is a 4-bit field that indicates the number of traffic congestion sections of the identified road. The user may infer whether the corresponding road is the traffic congestion section using the average speed defined by the “average_speed” field. However, it can be accurately judged whether the corresponding road is the traffic congestion section using the “num_of_jam” field. When the value of the “num_of_traffic congestion” field represents that there is at least one traffic congestion section, additional information may be defined by a loop structure for providing more detailed information of the traffic congestion sections.

Hereinafter, the fields constructing the loop structure of the “num_of_traffic congestion” field will be described.

A “start_area_name” is a variable-bit field that indicates the name of the start area of the traffic congestion section. An “end_area_name” is a variable-bit field that indicates the name of the end area of the traffic congestion section. A “speed” is an 8-bit field that indicates the speed or average speed of the traffic congestion section.

Up to now, the fields of the traffic descriptor including the traffic information was described.

Accordingly, the user can obtain the traffic information while viewing a broadcast program in real time using the traffic descriptor including the traffic information although the user does not view a additional data broadcasting or traffic broadcast program.

(2) Apparatus for Processing DTV Signal

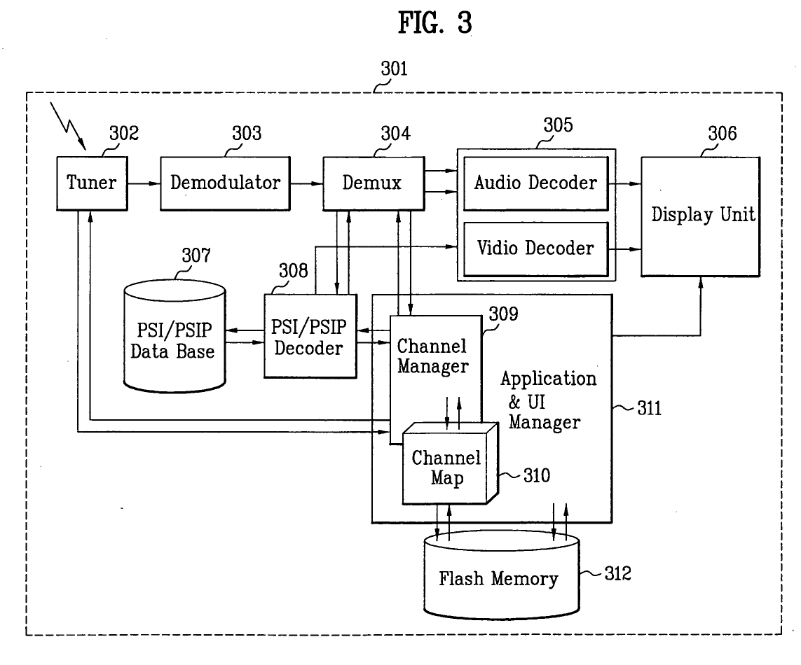

FIG. 3 is a block diagram of an exemplary DTV receiver.

The DTV receiver 301 includes a tuner 302, a demodulator 303, a demultiplexer 304, an audio/video (A/V) decoder 305, a display unit 306, a program specific information/program and system information protocol (PSI/PSIP) database 307, a PSI/PSIP decoder 308, a channel manager 309, a channel map 310, an application and user interface (UI) manager 311, and a flash memory 312.

The tuner 302 receives and tunes a DTV signal including a PSI/PSIP table. A specific table of the PSI/PSIP table comprises, for example, traffic information. The traffic information may be configured as shown in FIG. 2. The tuner 302 is controlled by the channel manager 309 such that the result of the received DTV signal is recorded in the channel manager 309.

The demodulator 303 receives and demodulates the DTV signal tuned by the tuner 302 into a vestigal side band/enhanced vestigal side band (VSB/EVSB) signal.

The demultiplexer 304 demultiplexes an audio, video, and the PSI/PSIP table from transport packets demodulated by the demodulator 303. The demultiplexing of the PSI/PSIP table is controlled by the PSI/PSIP decoder 308 and the demultiplexing of the audio and video is controlled by the channel manager 309. And, the demultiplexer 304 filters the PSI/PSIP table sections demultiplexed. When the PSI/PSIP decoder 308 parses a master guide table (MGT) and sets a packet identifier (PID) for a desired table as a condition, the demultiplexer 304 filters the sections of the PSI/PSIP table for satisfying the PID and transmits the sections to the PSI/PSIP decoder 308. When the channel manager 309 sets an A/V PID of a corresponding virtual channel as a condition, the demultiplexer 304 demultiplexes an A/V elementary stream (ES) and transmits the demultiplexed A/V ES to the A/V decoder 305.

The PSI/PSIP decoder 308 may parse the filtered PSI/PSIP table and record actual section data in the PSI/PSIP database 307. For example, the demultiplexer 804 filters the TVCT sections including traffic descriptor controlled by the PSI/PSIP decoder 808. The PSI/PSIP decoder 808 parses the filtered TVCT. And, the PSI/PSIP decoder 808 records the parsed TVCT information in the PSI/PSIP database 807.

The A/V decoder 305 receives and decodes the demultiplexed A/V data and outputs the decoded data to the display unit 306.

The channel manager 309 may request the reception of a channel-related information table by referring to the channel map 310 and receive the result. At this time, the PSI/PSIP decoder 308 controls the demultiplexing of the channel-related information table and transmits a list of A/V PIDs to the channel manager 309. The channel manager 309 may directly control the demultiplexer 304 using the received A/V PID to control the A/V decoder 305.

The application and UI manager 311 may control a graphical user interface (GUI) for displaying the state of the receiver with an on-screen display (OSD).

In particular, the demultiplexer 304 can check only the header of the table transmitted from the broadcasting station using the PID, table_id, version number, section_number, and table_id_extension field under the control of the PSI/PSIP decoder 308. Also, the demultiplexer 304 may filter VCT having only the updated version_number.

The PSI/PSIP decoder 308 parses the filtered VCT section. At this time, the traffic descriptor containing the traffic information in the VCT section is parsed and stored in the PSI/PSIP database 307. The traffic descriptor may be configured as shown in FIG. 2.

The application and UI manager 311 can receive a user input. The application and UI manager 311 controls the display 306 to display the traffic information stored in the PSI/PSIP database 307 when the user requests the display of the stored traffic information. In addition, when the traffic descriptor comprising the traffic information is included in the filtered VCT, the application and UI manager 311 configures a user interface and informs the user that the traffic information is received without unconditionally parsing the traffic descriptor. When the user confirms the reception of the traffic information through the UI and requests the display of the traffic information, the application and UI manager 311 may control the PSI/PSIP decoder 308 to parse the traffic descriptor.

Accordingly, the user can obtain the traffic information in real time without viewing the data broadcasting or traffic broadcast program.

(3) Method for Processing DTV Signal

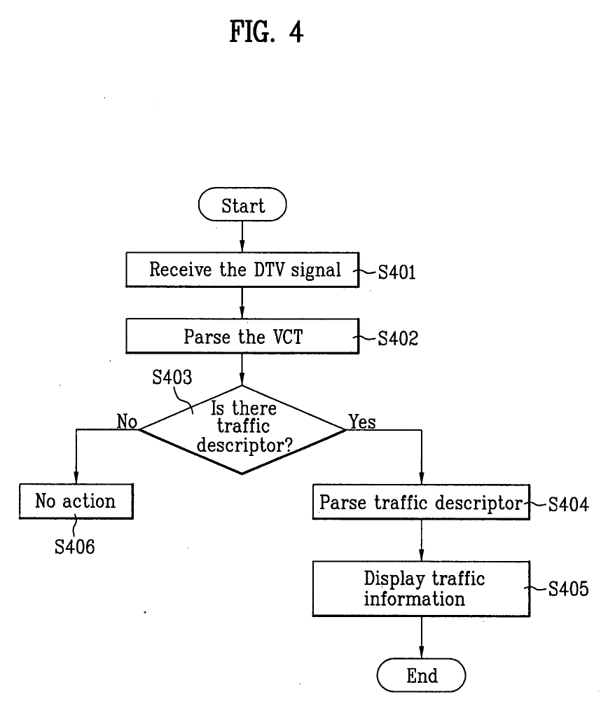

FIG. 4 is an exemplary flowchart of a method for processing the DTV signal including traffic information. FIG. 4 specifies a method for processing the traffic descriptor by the DTV receiver when the VCT including the traffic descriptor configured as shown in FIG. 2 is transmitted.

The DTV receiver receives the DTV signal (S401). At this time, the received DTV signal contains a plurality of PSI/PSIP tables.

The DTV receiver demodulates the PSI/PSIP tables in the received DTV signal and filters a virtual channel table (VCT) section in the PSI/PSIP tables. At this time, the PSI/PSIP decoder 308 parses the MGT having the PIDs of the all tables except for the STT and extracts the PID of the VCT section.

The DTV receiver parses the filtered VCT (S402). Then, the DTV receiver determines whether there is the traffic descriptor including traffic information in the parsed VCT (S403).

The DTV receiver parse the traffic descriptor in the VCT, if there is traffic descriptor including traffic information in the VCT (S404). Then, the DTV receiver stores the parsed traffic information in the parsed traffic descriptor in the PSI/PSIP database 307.

And, the DTV receiver extracts the stored traffic information and displays the extracted traffic information (S405).

For example, the DTV receiver may make a user interface associated with the traffic information. And, the DTV receiver may display the parsed traffic information if the user selects displaying the parsed traffic information.

The DTV receiver does not action, if there is not traffic descriptor in the VCT (S406).

Accordingly, only when the user previously inputs the information that the user wants to receive the traffic information, the descriptor for defining the traffic information is parsed and used in order of the flowchart shown in FIG. 4. When the user does not previously input the information, the descriptor for defining the traffic information does not need to be parsed and thus the receiver does not take any action.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of processing a digital television signal in a digital television receiver, the method comprising:
receiving a digital television signal including a virtual channel table carrying a list of attributes for virtual channels carried in transport streams included in the digital television signal;
parsing the virtual channel table, the parsed virtual channel table comprising traffic information defining traffic status associated with one or more roads; and
displaying the parsed traffic information.

2. The method of claim 1, wherein the traffic information comprises first information defining an identification of each road.

3. The method of claim 2, wherein the first information identifies a type, number, and name of each road.

4. The method of claim 3, wherein the type of each road is any one of a freeway, state highway, avenue, street, boulevard, and drive.

5. The method of claim 3, wherein the number of each road is a unique identification (ID) number of each road.

6. The method of claim 3, wherein the name of each road is a unique name of each road.

7. The method of claim 2, wherein the traffic information further comprises second information defining traffic status of each road.

8. The method of claim 7, wherein the second information identifies a direction, average speed, and speed unit of each road.

9. The method of claim 8, wherein the direction of each road is a reference direction of the traffic information provided.

10. The method of claim 9, wherein the reference direction is any one of directions from north to south, from south to north, from west to east, or from east to west.

11. The method of claim 8, wherein the speed unit of each road is any one of km/h and miles/h.

12. The method of claim 7, wherein the traffic information further comprises third information defining traffic congestion information of each road.

13. The method of claim 12, wherein the third information identifies a start area name, end area name, and speed of each road.

14. The method of claim 1, wherein the traffic information is streaming text data.

15. The method of claim 1 further comprising:
demultiplexing the virtual channel table in the digital television signal;
determining whether a version number of the demultiplexed virtual channel table is updated.

16. The method of claim 15, wherein the demultiplexed virtual channel table is discarded if the version number is not updated.

17. A digital television receiver, comprising:
a tuner arranged to receive a digital television signal;
a demodulator arranged to demodulate the digital television signal;
a demultiplexer arranged to demultiplex a virtual channel table from the demodulated digital television signal;
a decoder arranged to parse the virtual channel table, the parsed virtual channel table comprising a traffic information;
a display unit arranged to display the parsed traffic information; and
a controller arranged to control operation of the decoder and the display unit.

18. The receiver of claim 17, wherein the controller determines whether a version number of the demultiplexed virtual channel table is updated.

19. The receiver of claim 18, wherein the controller controls the decoder to discard the demultiplexed virtual channel table if the version number is not updated.
